(19) United States
(12) Patent Application Publication
(10) Pub. No.: US 2025/0244564 A1
(43) Pub. Date: Jul. 31, 2025

(54) OPTICAL SYSTEM AND IMAGING APPARATUS INCLUDING THE SAME

(71) Applicant: CANON KABUSHIKI KAISHA, Tokyo (JP)

(72) Inventor: KOHEI KIMURA, Saitama (JP)

(21) Appl. No.: 19/022,806

(22) Filed: Jan. 15, 2025

(30) Foreign Application Priority Data
Jan. 25, 2024 (JP) 2024-009256

(51) Int. Cl. G02B 13/02; G02B 7/02; G02B 13/00; G02B 27/00

(52) U.S. Cl. CPC G02B 13/02; G02B 7/025; G02B 13/006; G02B 27/0018

(57) ABSTRACT

An optical system consisting of a first lens unit having positive refractive power, an intermediate group including one or more lens units, and a final lens unit, disposed in this order from an object side to an image side, with a distance between adjacent lens units that changes during focusing, wherein the first and final lens units remain stationary for focusing, wherein the first lens unit consists of a first subunit including a plurality of positive lenses and a second subunit, disposed in this order from the object side to the image side, wherein the first and the second subunits are disposed with an air gap between the first and second subunits that is the largest air gap formed in the optical system, wherein the optical system satisfies the predetermined inequalities.

### BACKGROUND

### Technical Field

The aspect of the embodiments relates to an optical system suitable for use in imaging apparatuses, such as digital video cameras, digital still cameras, broadcast cameras, and silver halide film cameras.

### Description of the Related Art

Telephoto-type optical systems with a lens group having positive refractive power disposed on an object side and a lens group having negative refractive power disposed on an image side are known as optical systems with a long focal length. The telephoto-type optical systems are used in, for example, super-telephoto fixed focal length lenses.

In general, in optical systems with a constant f-number, an increase in the focal length of the lens increases the effective diameter of the lens. Thus, optical systems with a long focal length, in particular, require a lens that has a small f-number and is a compact and lightweight lens in which various aberrations are appropriately corrected.

Japanese Patent Application Laid-Open No. 2015-215561 discusses a telephoto-type optical system.

### SUMMARY

According to an aspect of the embodiments, an optical system includes a first lens unit having positive refractive power, an intermediate group including one or more lens units, and a final lens unit, disposed in this order from an object side to an image side, with a distance between adjacent lens units that changes during focusing, wherein the first and final lens units remain stationary for focusing, wherein the first lens unit consists of a first subunit including a plurality of positive lenses and a second subunit, disposed in this order from the object side to the image side, wherein the first and second subunits are disposed with an air gap between the first and second subunits that is the largest air gap formed in the optical system, wherein each of materials of at least three positive lenses disposed in the second subunit satisfies the following inequality:

70.0<νd<100.0,

where νd is an Abbe number based on the d-line, and wherein the following inequality is satisfied:

$$0.7 < D max / f 1 < 1.5 ,$$

where Dmax is the air gap between the first and second subunits, and f1 is a focal length of the first lens unit.

According to another aspect of the embodiments, an optical system including a first lens unit having positive refractive power, an intermediate group including one or more lens units, and a final lens unit, disposed in this order from an object side to an image side, with a distance between adjacent lens units that changes during focusing, wherein the first and final lens units remain stationary for focusing, wherein the first lens unit consists of a first subunit including a plurality of positive lenses and a second subunit, disposed in this order from the object side to the image side, wherein the first and second subunits are disposed with an air gap between the first and second subunits that is the largest air gap formed in the optical system, wherein the final lens unit includes four or more negative lenses, and wherein the following inequality is satisfied:

$$0.4 < D max / f 1 < 1.5 ,$$

where Dmax is the air gap between the first and second subunits, and f1 is a focal length of the first lens unit.

According to yet another aspect of the embodiments, an optical system including a first lens unit having positive refractive power, an intermediate group including one or more lens units, and a final lens unit, disposed in this order from an object side to an image side, with a distance between adjacent lens units that changes during focusing, wherein the first and final lens units remain stationary for focusing, wherein the first lens unit consists of a first subunit including a plurality of positive lenses and a second subunit, disposed in this order from the object side to the image side, wherein the first and second subunits are disposed with an air gap between the first and second subunits that is the largest air gap formed in the optical system, wherein the final lens unit includes four or more negative lenses, and wherein each of materials of at least three positive lenses disposed in the second subunit satisfies the following inequality:

70.0<νd<100.0,

where νd is an Abbe number based on the d-line.

Further features of the disclosure will become apparent from the following description of embodiments with reference to the attached drawings.

### BRIEF DESCRIPTION OF THE DRAWINGS

FIG. 1 is a lens cross-sectional view illustrating an optical system focused at infinity according to a first example.

FIG. 2A is an aberration diagram of the optical system focused at infinity according to the first example, and FIG. 2B is an aberration diagram of the optical system focused at a close distance according to the first example.

FIG. 3 is a lens cross-sectional view illustrating an optical system focused at infinity according to a second example.

FIG. 4A is an aberration diagram of the optical system focused at infinity according to the second example, and FIG. 4B is an aberration diagram of the optical system focused at a close distance according to the second example.

FIG. 5 is a lens cross-sectional view illustrating an optical system focused at infinity according to a third example.

FIG. 6A is an aberration diagram of the optical system focused at infinity according to the third example, and FIG. 6B is an aberration diagram of the optical system focused at a close distance according to the third example.

FIG. 7 is a lens cross-sectional view illustrating an optical system focused at infinity according to a fourth example.

FIG. 8A is an aberration diagram of the optical system focused at infinity according to the fourth example, and FIG. 8B is an aberration diagram of the optical system focused at a close distance according to the fourth example.

FIG. 9 is a lens cross-sectional view illustrating an optical system focused at infinity according to a fifth example.

FIG. 10A is an aberration diagram of the optical system focused at infinity according to the fifth example, and FIG. 10B is an aberration diagram of the optical system focused at a close distance according to the fifth example.

FIG. 11 is a schematic diagram illustrating an imaging apparatus.

### DESCRIPTION OF THE EMBODIMENTS

Hereinafter, exemplary embodiments of the disclosure and examples of the respective exemplary embodiments will be described with reference to the accompanying drawings.

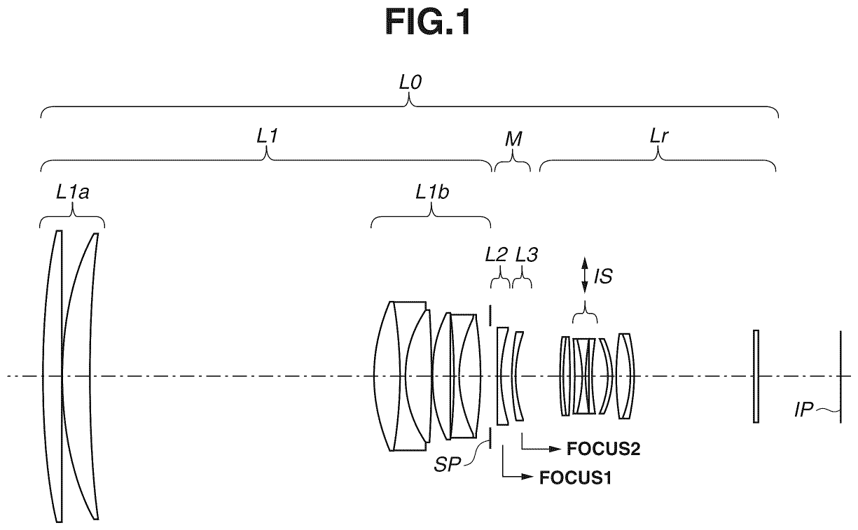

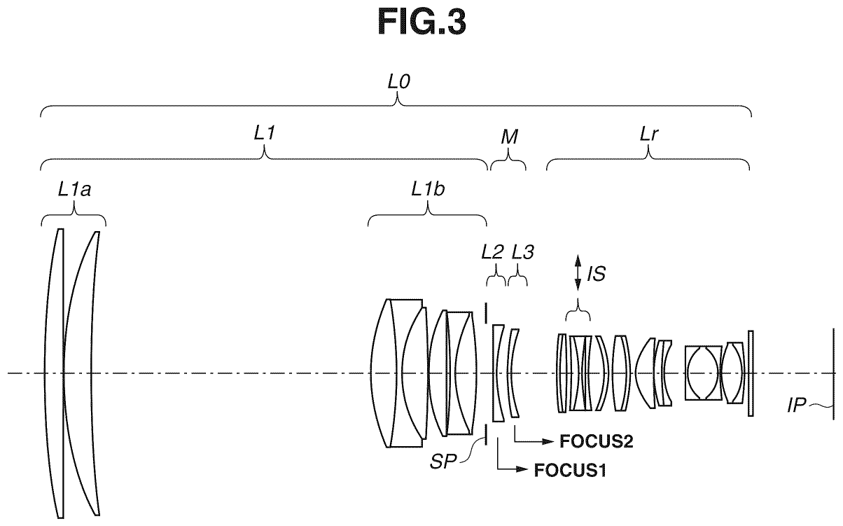

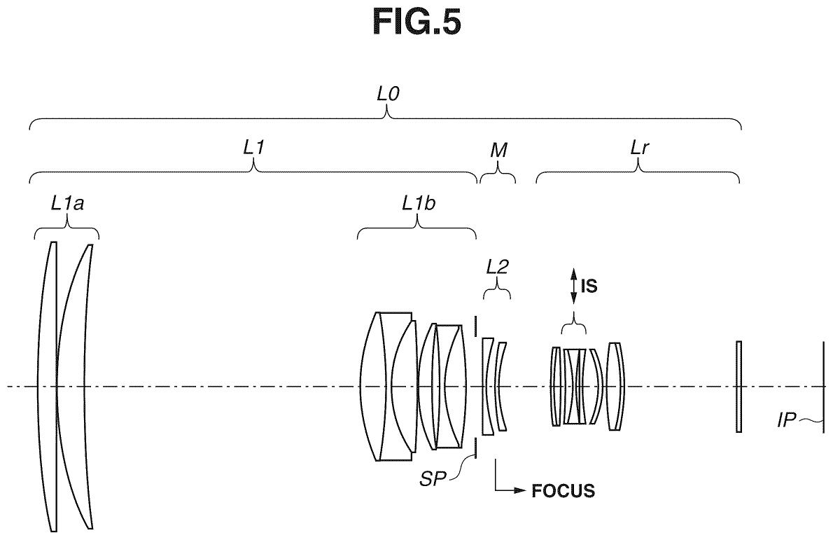

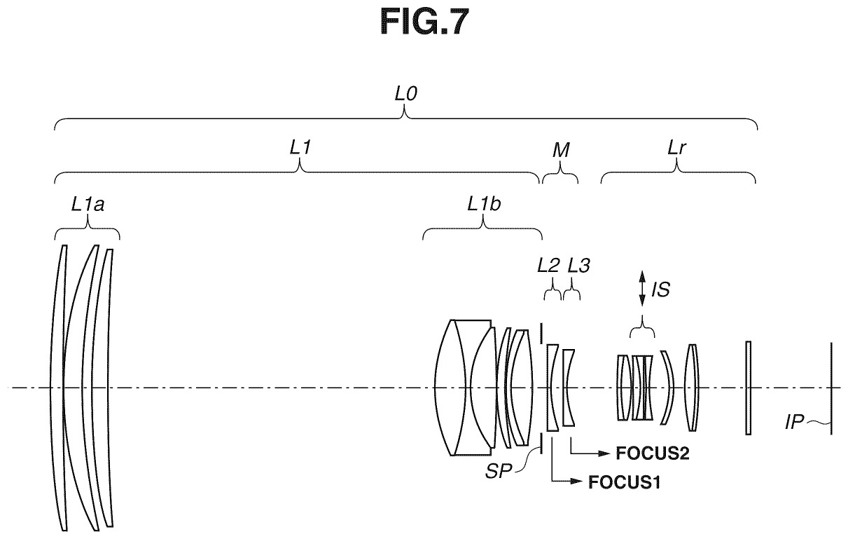

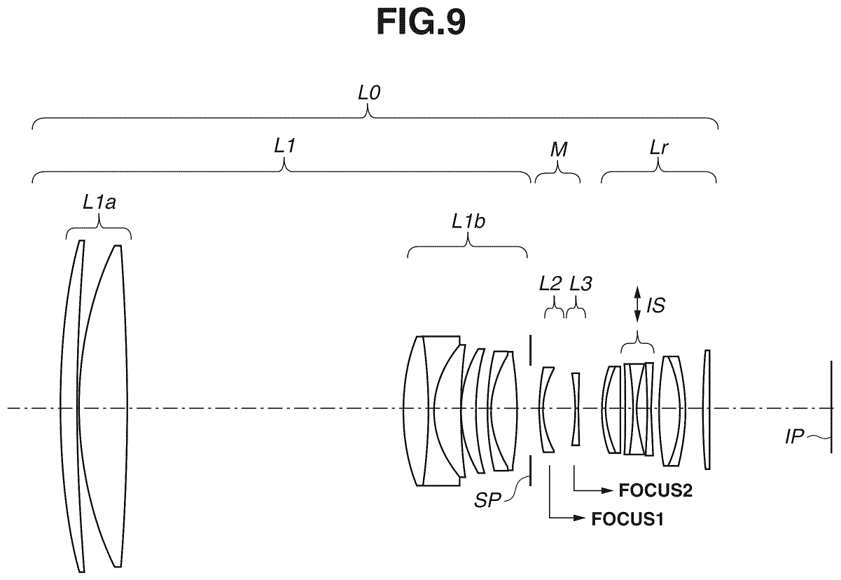

FIGS. 1, 3, 5, 7, and 9 are lens cross-sectional views illustrating optical systems L0 focused at infinity according to first to fifth examples of first to fifth exemplary embodiments. The optical system L0 according to each example is an optical system for use in imaging apparatuses, such as digital video cameras, digital still cameras, broadcast cameras, silver halide film cameras, monitoring cameras, and in-vehicle cameras.

In each lens cross-sectional view, the left side represents an object side, and the right side represents an image side. The optical system L0 according to each example may be used as a projection lens of a projector. In this case, the left side represents a screen side, and the right side represents a projected image side.

The optical systems L0 according to the first to fifth examples of the first to fifth exemplary embodiments each consist of a first lens group L1, an intermediate group M including one or more lens groups, and a final lens group Lr, arranged in this order from the object side to the image side, and a distance between adjacent lens groups changes during focusing. Each lens group may be composed of a single lens or a plurality of lenses. The lens units may include an aperture stop.

In the lens cross-sectional views, solid arrows pointing downward represent movement trajectories of each lens unit during focusing from infinity to close distance.

In the lens cross-sectional views, there is an aperture stop SP. At an image plane IP, a sensing surface of a solid-state image sensor (photoelectric conversion element), such as a charge-coupled device (CCD) sensor or a complementary metal-oxide-semiconductor (CMOS) sensor, is disposed to use the optical system L0 according to each embodiment in a digital still camera or a digital video camera. In the case of using the optical system L0 according to each embodiment as an imaging optical system of a silver halide film camera, a photosensitive surface equivalent to a film plane is disposed at the image plane IP.

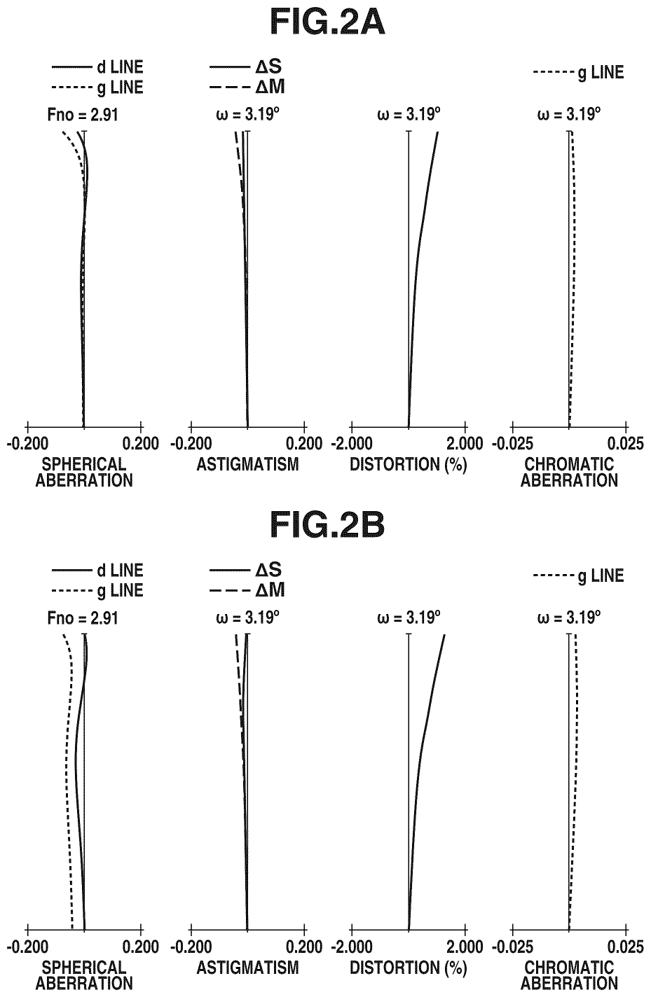

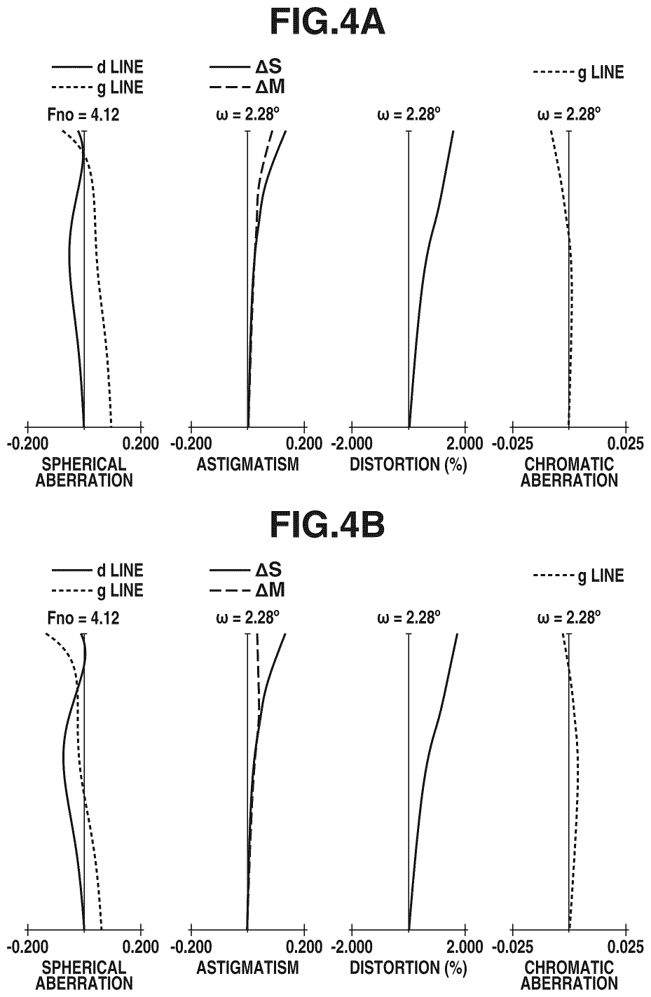

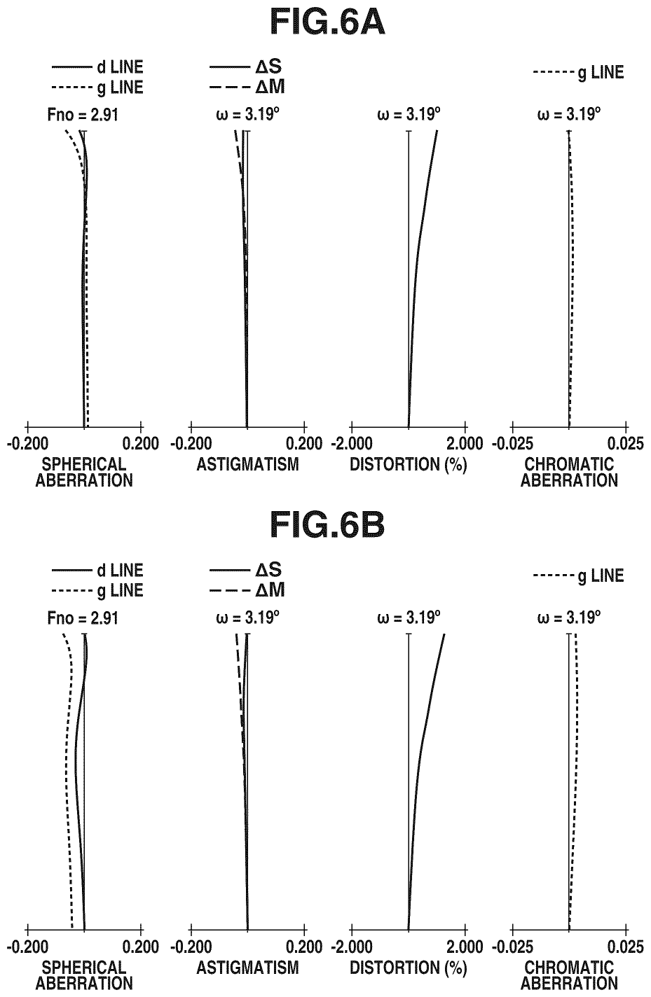

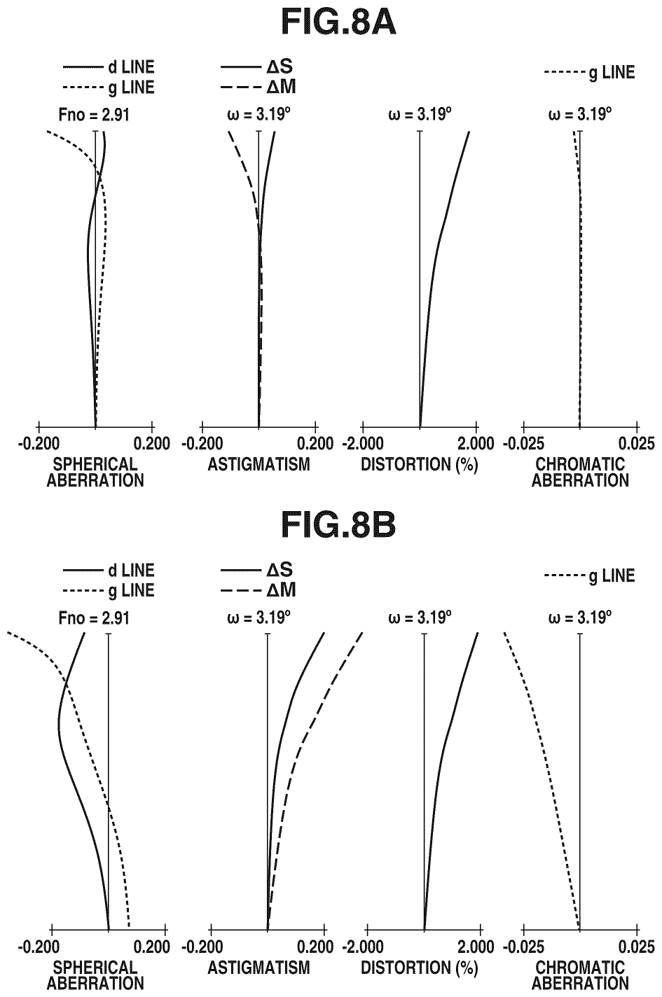

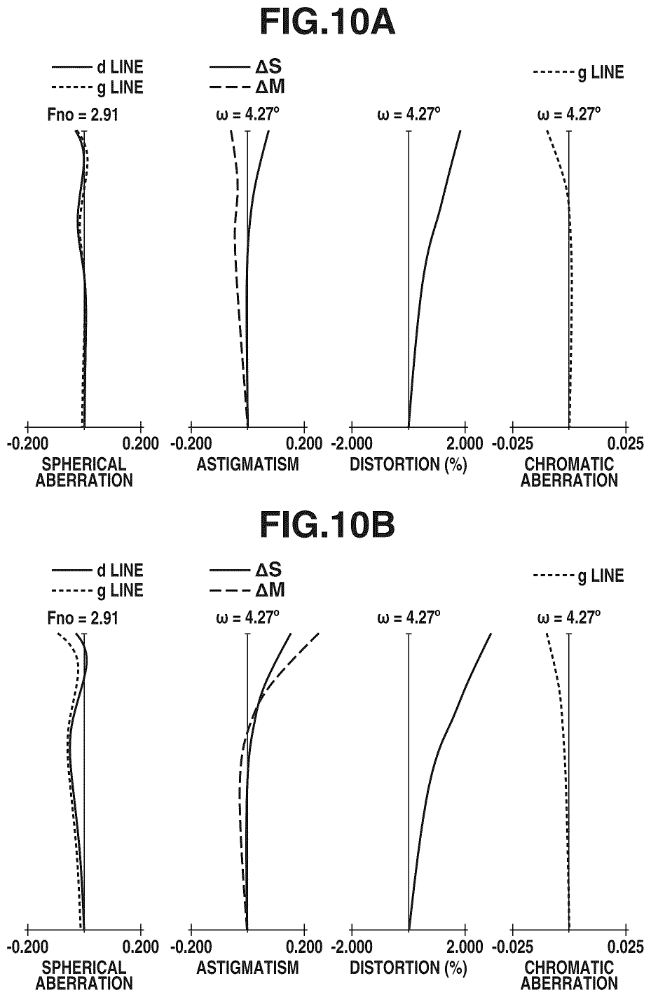

FIGS. 2A, 4A, 6A, 8A, and 10A are aberration diagrams of the optical systems focused at infinity according to the first to fifth examples of the first to fifth exemplary embodiments.

FIGS. 2B, 4B, 6B, 8B, and 10B are aberration diagrams of the optical systems focused at a close distance according to the first to fifth examples of the first to fifth exemplary embodiments.

In spherical aberration diagrams, an f-number Fno is specified, and each solid line represents an amount of spherical aberration relative to the d-line (wavelength 587.6 nm), whereas each dashed line represents an amount of spherical aberration relative to the g-line (wavelength 435.8 nm). In astigmatism diagrams, each solid line represents an amount of aberration ΔS on a sagittal image plane, whereas each dashed line represents an amount of aberration ΔM on a meridional image plane. In distortion aberration diagrams, amounts of distortion aberration relative to the d-line are presented. In chromatic aberration diagrams, amounts of magnification chromatic aberration relative to the g-line are presented. Each half angle of view ω (°) is specified.

The optical system L0 according to the first exemplary embodiment will be described below.

The optical system L0 according to the first exemplary embodiment consists of the first lens group L1 having positive refractive power, the intermediate group M including one or more lens groups, and the final lens group Lr, disposed in this order from the object side to the image side, and a distance between adjacent lens groups changes during focusing.

Since the first lens group L1 has positive refractive power, a principal point of the optical system L0 is on the object side, reducing a total lens length of the optical system L0. The total lens length herein refers to a value obtained by adding a back focus to a distance along an optical axis from a lens surface closest to the object side to a lens surface closest to the image side in the optical system L0. The back focus herein refers to an air-equivalent value of a distance along the optical axis between the lens surface closest to the image side and the image plane in the optical system L0.

During focusing, the first lens group L1 and the final lens group Lr remain stationary while the lens units disposed in the intermediate group M move. Since the first lens group L1 is heavy in mass due to its relatively large diameter and the final lens group Lr has a relatively high off-axis ray height, moving the final lens group Lr during focusing causes pronounced variations in, for example, field curvature, that occur during focusing. For this reason, the first lens group L1 and the final lens group Lr remain stationary while the lens units disposed in the intermediate group M move during focusing, whereby aberration variations during focusing are appropriately corrected while high-speed focusing is achieved.

The first lens group L1 consists of a first subgroup L1a including a plurality of positive lenses and a second subgroup L1b, disposed in this order from the object side to the image side. The first subgroup L1a and the second subgroup L1b are disposed with the air gap between the first subgroup L1a and the second subgroup L1b that is the largest air gap formed in the optical system L0. Since the first subgroup L1a includes the plurality of positive lenses, spherical aberration in the first subgroup L1a is appropriately corrected.

In telephoto-type optical systems, generally, an axial light beam incident from the object side converges toward the image side. Thus, disposing the first subgroup L1a and the second subgroup L1b with an air gap between the first subgroup L1a and the second subgroup L1b that is the largest air gap formed in the optical system L0 enables a reduction in the diameters of lenses disposed in or beyond the second subgroup L1b. This enables the optical system L0 to be lightweight.

The optical system L0 according to the first exemplary embodiment is configured to satisfy the following inequalities:

$$70. < vd < 100. , and \qquad ( 1 )$$

$$0.7 < D max / f 1 < 1.5 . \qquad ( 2 )$$

In inequality (1), νd is an Abbe number based on the d-line, and a material of at least three positive lenses disposed in the second subgroup L1b satisfies inequality (1). Dmax is the air gap between the first subgroup L1a and the second subgroup L1b, and f1 is a focal length of the first lens group L1. The air gap refers to an air gap on the optical axis.

Inequality (1) is to achieve the effect of chromatic aberration correction by the positive lenses disposed in the second subgroup L1b, and the inclusion of three or more positive lenses that satisfy inequality (1) facilitates appropriate correction of axial and magnification chromatic aberrations in the optical system L0.

If the Abbe number νd is excessively small and falls below the lower limit of inequality (1), the positive lens material is excessively dispersive, leading to an increase in axial and magnification chromatic aberrations, which is undesirable. Optical glass having the Abbe number νd exceeding the upper limit of inequality (1) does not exist. If the number of positive lenses that satisfy inequality (1) is two or less, the refractive power of the positive lenses is enhanced to obtain a sufficient effect of chromatic aberration correction, leading to increased spherical aberration, which is undesirable.

Inequality (2) is to achieve a configuration that facilitates a reduction in the mass of the optical system L0, and obtains appropriate refractive power of the first lens group L1. If the Dmax is small to the extent that the Dmax/f1 falls significantly below the lower limit of inequality (2), particularly falls below 0.40, diameters of the lenses disposed within and beyond the second subgroup L1b are increased, causing the optical system L0 to be excessively heavy in mass. In one embodiment, the Dmax is large enough to obtain 0.70 or more, enabling a configuration that facilitates a reduction in the mass of the optical system L0.

If the Dmax/f1 exceeds the upper limit of inequality (2), and the refractive power of the first lens group L1 increases, spherical aberration in the first lens group L1 increases, which is undesirable.

By satisfying the foregoing configuration, the optical system L0 according to the first exemplary embodiment achieves high optical performance, a long focal length, compact in size, and lightweight.

In one embodiment, at least one of the upper and lower limits of the numerical ranges of inequalities (1) and (2) is set to a value specified by the following inequalities (1a) and (2a):

$$75. < vd < 98. , and \qquad ( 1 a )$$

$$0.72 < D max / f 1 < 1.4 . \qquad ( 2 a )$$

In another embodiment, at least one of the upper and lower limits of the numerical ranges of inequalities (1) and (2) is set to a value specified by the following inequalities (1b) and (2b):

$$80. < vd < 96. , and \qquad ( 1 b )$$

$$0.74 < D max / f 1 < 1.3 . \qquad ( 2 b )$$

The optical system L0 according to the second exemplary embodiment will be described below.

The optical system L0 according to the second exemplary embodiment consists of the first lens group L1 having positive refractive power, the intermediate group M including one or more lens groups, and the final lens group Lr, disposed in this order from the object side to the image side, and the distance between adjacent lens groups changes during focusing.

Since the first lens group L1 has positive refractive power, the principal point of the optical system L0 is on the object side, reducing the total lens length of the optical system L0. The total lens length herein refers to the value obtained by adding the back focus to the distance along the optical axis from the surface closest to the object side to the surface closest to the image side in the optical system L0. The back focus herein refers to the air-equivalent value of the distance along the optical axis between the surface closest to the image side in the optical system L0 and the image plane.

During focusing, the first lens group L1 and the final lens group Lr remain stationary while the lens groups disposed in the intermediate group M move. Since the first lens group L1 is heavy in mass due to its relatively large diameter and the final lens group Lr has a relatively high off-axis ray height, moving the final lens group Lr during focusing causes pronounced variations in, for example, field curvature, that occur during focusing. For this reason, the first lens group L1 and the final lens group Lr remain stationary while the lens units disposed in the intermediate group M move during focusing, whereby aberration variations during focusing are suppressed while high-speed focusing is achieved.

The first lens group L1 consists of a first subgroup L1a including a plurality of positive lenses and a second subgroup L1b, disposed in this order from the object side to the image side. The first subgroup L1a and the second subgroup L1b are disposed with an air gap between the first subgroup L1a and the second subgroup L1b that is the largest air gap formed in the optical system L0. Since the first subgroup L1a includes the plurality of positive lenses, spherical aberration is effectively corrected.

In telephoto-type optical systems, generally, an axial light beam incident from the object side converges toward the image side. Thus, disposing the first subgroup L1a and the second subgroup L1b with the air gap between the first subgroup L1a and the second subgroup L1b that is the largest air gap formed in the optical system L0 enables the reduction in the diameters of lenses disposed in or beyond the second subgroup L1b. This enables the optical system L0 to be lightweight.

The final lens group Lr includes four or more negative lenses. The inclusion of four or more negative lenses effectively reduces the Petzval sum of the optical system L0, whereby the field curvature is corrected.

The optical system L0 according to the second exemplary embodiment is configured to satisfy the following inequality:

$$0.4 < D max / f 1 < 1.5 . \qquad ( 2 c )$$

Dmax is the air gap between the first subgroup L1a and the second subgroup L1b, and f1 is a focal length of the first lens group L1. The air gap refers to an air gap on the optical axis.

Inequality (2c) is to reduce the mass of the optical system L0 and obtain appropriate refractive power of the first lens group L1. If the Dmax is small to the extent that Dmax/f1 falls below the lower limit of inequality (2c), diameters of the lenses disposed within and beyond the second subgroup L1b are increased, causing the optical system L0 to be excessively heavy in mass. If the Dmax/f1 exceeds the upper limit of inequality (2c), and the refractive power of the first lens group L1 increases, spherical aberration in the first lens group L1 increases, which is undesirable.

By satisfying the foregoing configuration, the optical system L0 according to the second exemplary embodiment achieves high optical performance, a long focal length, compact in size, and lightweight.

In one embodiment, at least one of the upper and lower limits of the numerical range of inequality (2c) is set to a value specified by the following inequality (2d):

$$0.5 < D max / f 1 < 1.4 . \qquad ( 2 d )$$

In another embodiment, at least one of the upper and lower limits of the numerical range of inequality (2c) is set to a value specified by the following inequality (2e):

$$0.6 < D max / f 1 < 1.3 . \qquad ( 2 e )$$

The optical system L0 according to the third exemplary embodiment will be described below.

The optical system L0 according to the third exemplary embodiment consists of the first lens group L1 having positive refractive power, the intermediate group M including one or more lens units, and the final lens group Lr, disposed in this order from the object side to the image side, and the distance between adjacent lens units changes during focusing.

Since the first lens group L1 has positive refractive power, the principal point of the optical system L0 is on the object side, reducing the total lens length of the optical system L0. The total lens length herein refers to the value obtained by adding the back focus to the distance along the optical axis from the surface closest to the object side to the surface closest to the image side in the optical system L0. The back focus herein refers to the air-equivalent value of the distance along the optical axis between the surface closest to the image side in the optical system L0 and the image plane.

During focusing, the first lens group L1 and the final lens group Lr remain stationary while the lens units disposed in the intermediate group M move. Since the first lens group L1 is heavy in mass due to its relatively large diameter and the final lens group Lr has a relatively high off-axis ray height, moving the final lens group Lr during focusing causes pronounced variations in, for example, field curvature, that occur during focusing. For this reason, the first lens group L1 and the final lens group Lr remain stationary while the lens units arranged in the intermediate group M move during focusing, whereby aberration variations during focusing are suppressed while high-speed focusing is achieved.

The first lens group L1 consists of a first subgroup L1a including a plurality of positive lenses and a second subgroup L1b, disposed in this order from the object side to the image side. The first subgroup L1a and the second subgroup L1b are disposed with an air gap between the first subgroup L1a and the second subgroup L1b that is the largest air gap formed in the optical system L0. Since the first subgroup L1a includes the plurality of positive lenses, spherical aberration is effectively corrected.

In telephoto-type optical systems, generally, an axial light beam incident from the object side converges toward the image side. Thus, disposing the first subgroup L1a and the second subgroup L1b with the air gap between the first subgroup L1a and the second subgroup L1b that is the largest air gap formed in the optical system L0 enables the reduction in the diameters of lenses disposed in or beyond the second subgroup L1b. This enables the optical system L0 to be lightweight.

The final lens group Lr includes four or more negative lenses. The inclusion of four or more negative lenses effectively reduces the Petzval sum of the optical system L0, whereby the field curvature is corrected.

The optical system L0 according to the third exemplary embodiment is configured to satisfy the following inequality:

70.0<νd<100.0 (1).

In inequality (1), νd is an Abbe number based on the d-line, and a material of at least three positive lenses disposed in the second subgroup L1b satisfies inequality (1).

Inequality (1) is to achieve the effect of chromatic aberration correction by the positive lenses disposed in the second subgroup L1b, and with the three or more positive lenses that satisfy inequality (1), axial and magnification chromatic aberrations in the optical system L0 are appropriate corrected.

If the Abbe number νd is small to the extent that the value falls below the lower limit of inequality (1), the positive lens material is excessively dispersive, leading to increased axial and magnification chromatic aberrations, which is undesirable. Optical glass having the value exceeding the upper limit of inequality (1) does not exist. If the number of positive lenses that satisfy inequality (1) is two or less, the refractive power of the positive lenses is enhanced to obtain a sufficient effect of chromatic aberration correction, leading to increased spherical aberration, which is undesirable.

By satisfying the foregoing configuration, the optical system L0 according to the third exemplary embodiment achieves high optical performance, a long focal length, compact in size, and lightweight.

In one embodiment, at least one of the upper and lower limits of the numerical range of inequality (1) is set to a value specified by the following inequality (1a):

75.0<νd<98.0 (1a).

In another embodiment, at least one of the upper and lower limits of the numerical range of inequality (1) is set to a value specified by the following inequality (1b):

80.0<νd<96.0 (1b).

Configurations of the optical system L0 according to each exemplary embodiment will be described below.

In one embodiment, the first subgroup L1a consists of two positive lenses. With the two positive lenses, a mass reduction is enabled while spherical aberration in the first subgroup L1a is reduced.

In one embodiment, the intermediate group M has negative refractive power. Having negative refractive power enables appropriate correction of field curvature in the optical system L0.

In one embodiment, the second subgroup L1b includes two negative lenses. With the two negative lenses, axial chromatic aberration in the first subgroup L1a is appropriately corrected.

In one embodiment, the final lens group Lr moves partially or entirely in a direction that includes a component of a direction perpendicular to the optical axis during image blur correction. The lenses disposed in the final lens group Lr have a relatively small diameter in the optical system L0, enabling mass reduction of one or more lenses that move during image blur correction.

In one embodiment, the optical system L0 includes the aperture stop SP disposed closest to the image side in the first lens group L1. With the aperture stop SP disposed closest to the image side in the first lens group L1, the height of off-axis rays passing through the final lens group Lr from the optical axis is particularly reduced, enabling mass reduction of the final lens group Lr.

In one embodiment, four positive lenses are disposed in the second subgroup L1b. With the four positive lenses, the refractive power of the second subgroup L1b is appropriately strengthened, shortening the total lens length of the optical system L0 while spherical aberration is appropriately corrected.

In one embodiment, the intermediate group M includes a negative meniscus lens with a convex surface facing the object side. With the negative meniscus lens with the convex surface facing the object side, spherical aberration is enables appropriately corrected.

In one embodiment, the final lens group Lr includes three or more cemented lenses. Since lenses disposed close to the image plane are prone to ghosting, the cemented lenses are disposed close to the image plane, whereby magnification chromatic aberration and field curvature are appropriately corrected while ghosting is suppressed.

In one embodiment, final lens group Lr includes a cemented lens composed of three lenses that are negative, positive, and negative lenses, arranged in this order from the object side to the image side. Since lenses disposed close to the image plane are prone to ghosting, the cemented lenses are disposed close to the image plane, whereby magnification chromatic aberration and field curvature are appropriately corrected while ghosting is suppressed.

In one embodiment, the optical system L0 according to each example satisfies one or more of the following inequalities:

$$0.45 < OTL / f < 1.2 , \qquad ( 3 )$$

$$0.2 < f 1 a / f < 1. , \qquad ( 4 )$$

$$0.2 < f 1 / f < 0.8 , \qquad ( 5 )$$

$$1. < f1a\_min / f 1 < 8. , \qquad ( 6 )$$

$$10. < vd\_min < 35. , \qquad ( 7 )$$

$$0.5 < Bab\_max / Fno < 2. , \qquad ( 8 )$$

$$1.3 < BF / IH < 5. , and \qquad ( 9 )$$

$$0.1 < f 1 b / f < 0.8 . \qquad ( 10 )$$

In the foregoing inequalities, OTL is a distance along the optical axis from the lens surface closest to the object side to the image plane in the optical system L0, f is a focal length of the entire system, i.e., the optical system L0, f1a is a focal length of the first subgroup L1a, f1a_min is a focal length of a positive lens with the shortest focal length among the positive lenses disposed in the first lens group L1, and νd_min is a minimum value of the Abbe number of the material of the positive lenses disposed in the first subgroup L1a.

Bab_max is a maximum absolute value of position sensitivity of the lens groups disposed in the intermediate group M and configured to move during focusing, Fno is an f-number of the optical system L0, BF is a distance along the optical axis from the lens surface closest to the image side to the image plane in the optical system L0, IH is a maximum image height in the optical system L0, and f1b is a focal length of the second subgroup L1b. The maximum image height herein refers to an image height at which peripheral illumination is 20% relative to an on-axis image point.

Next, the technical meanings of inequalities (3) to (10) will be described below.

If OTL/f falls below the lower limit of inequality (3), and the distance along the optical axis from the lens surface closest to the object side to the image plane in the optical system L0 is shortened, the refractive power of each lens group, such as the first lens group L1, is excessively high, leading to an increase in various aberrations, which is undesirable. If the OTL/f exceeds the upper limit of inequality (3), the total lens length increases, which is undesirable.

If f1a/f falls below the lower limit of inequality (4), and the refractive power of the first subgroup L1a is excessively high, spherical aberration in the first subgroup L1a increases, which is undesirable. If the f1a/f exceeds the upper limit of inequality (4), and the refractive power of the first subgroup L1a is excessively low, the principal point of the optical system L0 is on the image side. Consequently, the total lens length increases, which is undesirable.

If f1/f falls below the lower limit of inequality (5), and the refractive power of the first lens group L1 is excessively high, spherical aberration in the first lens group L1 increases, which is undesirable. If the f1/f exceeds the upper limit of inequality (5), and the refractive power of the first lens group L1 is excessively low, the principal point of the optical system L0 is on the image side. Consequently, the total lens length increases, which is undesirable.

If f1a_min/f1 falls below the lower limit of inequality (6), and the refractive power of the positive lens with the shortest focal length among the positive lenses disposed in the first lens group L1 is excessively high, spherical aberration in the positive lens with the shortest focal length increases, which is undesirable. If the f1a_min/f1 exceeds the upper limit of inequality (6), and the refractive power of the positive lens with the shortest focal length among the positive lenses disposed in the first lens group L1 is excessively low, spherical aberration in the positive lenses other than the positive lens with the shortest focal length in the first lens group L1 increases, which is undesirable.

Inequality (7) defines the minimum value of the Abbe number of the material of the positive lenses disposed in the second subgroup L1b to correct short-wavelength, i.e., secondary axial chromatic aberration. If the value falls below the lower limit of inequality (7), the minimum value of the Abbe number of the positive lens is excessively small, leading to an increase in primary axial chromatic aberration, which is undesirable. If the value exceeds the upper limit of inequality (7), the minimum value of the Abbe number of the positive lens is excessively large. Consequently, the partial dispersion ratio of the positive lens for the g-line and F-line is excessively small, leading to an increase in secondary axial chromatic aberration, which is undesirable.

Inequality (8) defines the ratio between the position sensitivity of the lens group, having the highest position sensitivity among the lens groups disposed in the intermediate group M and configured to move during focusing, and the f-number for high-speed, high-precision focusing and miniaturization.

The position sensitivity herein refers to an amount of image plane movement when the lens unit moves by a unit distance in the optical axis direction, and is expressed by the following equation using a lateral magnification Bf of the lens group and a combined lateral magnification Br of all lenses disposed on the image side of the lens group:

$$B = ( 1 - β f \times β f ) \times β r \times β r .$$

If Bab_max/Fno falls below the lower limit of inequality (8), the amount of movement of the lens unit during focusing increases, which leads to an increase in air gap for movement in the optical axis direction. Consequently, the total lens length of the optical system L0 increases, which is undesirable. If the Bab_max/Fno exceeds the upper limit of inequality (8), the position sensitivity of the lens group that moves during focusing is excessively high relative to the f-number. Consequently, the amount of focus shift caused by deviations in stop position during focusing increases, which is undesirable.

If BF/IH falls below the lower limit of inequality (9), the distance along the optical axis from the lens surface closest to the image side to the image plane in the optical system L0 is excessively short. If the image sensor is disposed at the image plane, ghosting due to reflections between the image sensor and the lens surface closest to the image side in the optical system L0 is noticeable, which is undesirable. If the BF/IH exceeds the upper limit of inequality (9), the total lens length of the optical system L0 increases, which is undesirable.

If f1b/f falls below the lower limit of inequality (10), and the refractive power of the second subgroup L1b is excessively high, spherical aberration in the second subgroup L1b increases, which is undesirable. If the f1b/f exceeds the upper limit of inequality (10), and the refractive power of the second subgroup L1b is excessively low, the principal point of the optical system L0 is on the image side. Consequently, the total lens length increases, which is undesirable.

In one embodiment, at least one of the upper and lower limits of inequalities (2) to (10) is set as specified by the following numerical ranges:

$$0.6 < OTL / f < 1.15 , \qquad ( 3 a )$$

$$0.4 < f 1 a / f < 0.95 , \qquad ( 4 a )$$

$$0.25 < f 1 / f < 0.7 , \qquad ( 5 a )$$

$$2. < f 1 a\_min / f 1 < 7. , \qquad ( 6 a )$$

$$15. < vd\_min < 34.5 , \qquad ( 7 a )$$

$$1. < Bab\_max / Fno < 1.98 , \qquad ( 8 a )$$

$$1.4 < BF / IH < 3. , and \qquad ( 9 a )$$

$$0.15 < f 1 b / f < 0.6 . \qquad ( 10 a )$$

In another embodiment, at least one of the upper and lower limits of inequalities (2) to (10) is set as specified by the following numerical ranges:

$$0.8 < OTL / f < 1.1 , \qquad ( 3 b )$$

$$0.6 < f 1 a / f < 0.9 , \qquad ( 4 b )$$

$$0.3 < f 1 / f < 0.5 , \qquad ( 5 b )$$

$$2.5 < f 1 a\_min / f 1 < 6.5 , \qquad ( 6 b )$$

$$25. < vd\_min < 34. , \qquad ( 7 b )$$

$$1.2 < Bab\_max / Fno < 1.95 , \qquad ( 8 b )$$

$$1.5 < BF / IH < 2. , and \qquad ( 9 b )$$

$$0.2 < f 1 b / f < 0.5 . \qquad ( 10 b )$$

Details of the configurations of the optical systems L0 according to the first to fifth examples of the first to fifth exemplary embodiments will be described below. The second example and subsequent examples primarily focus on the differences from the first example.

### First Example

The optical system L0 according to the first example consists of the first lens group L1 with positive refractive power, the intermediate group M, and the final lens group Lr, disposed in this order from the object side to the image side, and the distance between adjacent lens groups changes during focusing. The first lens group L1 and the final lens group Lr remain stationary during focusing.

The intermediate group M consists of a second lens group L2 and a third lens group L3, and the movement amount of the second lens group L2 and the movement amount of the third lens group L3 are different from each other to achieve focusing. With the two lens groups configured to move for focusing, variations in various aberrations during focusing is easily suppressed. Furthermore, both the second lens group L2 and the third lens group L3 are each composed of a negative single lens, enabling mass reduction of the lens groups that move during focusing.

The first subgroup L1a and the second subgroup L1b are disposed with the air gap between the first subgroup L1a and the second subgroup L1b that is the largest air gap formed in the optical system L0, and the first subgroup L1a is composed of two positive lenses including a positive meniscus lens with a convex surface facing the object side. A marginal ray along the optical axis, incident from the object side, enters a lens surface of the positive meniscus lens with the convex surface facing the object side at an angle close to perpendicular, whereby spherical aberration is easily suppressed.

During image blur correction, three lenses disposed in the final lens group Lr move in the direction that includes the component of the direction perpendicular to the optical axis. By configuring three lenses to move, variations in various aberrations during image blur correction is easily suppressed.

The second subgroup L1b includes three biconvex lenses. With the three biconvex lenses, the refractive power of the second subgroup L1b is easily increased, while the total lens length of the optical system L0 is reduced.

### Second Example

The second example adds a subgroup having negative refractive power on the image side of the final lens group Lr according to the first example. This enables a further increase in focal length compared to the first example. With a plurality of positive lenses and a plurality of negative lenses in the subgroup having negative refractive power, field curvature and magnification chromatic aberration are easily suppressed.

### Third Example

The intermediate group M according to the third example consists of the second lens group L2, and the second lens group L2 moves during focusing. With the one lens group configured to move during focusing, aberration variations caused by relative decentering between adjacent lens groups during focusing is easily suppressed.

### Fourth Example

The first subgroup L1a according to the fourth example is composed of three positive lenses. With the three positive lenses, spherical aberration in the first subgroup L1a is easily suppressed.

### Fifth Example

The second subgroup L1b according to the fifth example includes two positive meniscus lenses with a convex surface facing the object side. With this configuration, spherical aberration is easily suppressed.

First to fifth numerical examples respectively corresponding to the first to fifth examples will be described below.

In surface data of each numerical example, r represents the radius of curvature of each optical surface, and d (mm) represents the axial distance (the distance along the optical axis) between the mth and (m+1)th surfaces, where m is the surface number counted from the light incident side. Further, nd represents the refractive index of an optical member with respect to the d-line, and νd represents the Abbe number of the optical member. The Abbe number νd of a material is represented by:

$$vd = ( Nd - 1 ) / ( NF - NC ) ,$$

where Nd, NF, and NC are the refractive indices for the Fraunhofer d-line (wavelength 587.6 nm), F-line (wavelength 486.1 nm), C-line (wavelength 656.3 nm), and g-line (wavelength 435.8 nm).

BF is the back focus.

For each optical surface that is aspheric, an asterisk (*) symbol is placed to the right of its surface number. An aspheric surface is represented by the following formula:

$$x = ( {h}^{2} / R ) / [ 1 + {\{ 1 - ( 1 + k ) {( h / R )}^{2} \}}^{1 / 2} ] + A 4 \times {h}^{4} + A 6 \times {h}^{6} + A 8 \times {h}^{8} + A 10 \times {h}^{10} + A 12 \times {h}^{12} ,$$

where X is an amount of displacement from a surface vertex in the optical axis direction, h is a height from the optical axis in the direction perpendicular to the optical axis, R is a paraxial radius of curvature, k is a conic constant, and A4, A6, A8, A10, and A12 are aspheric coefficients for each order. In each aspheric coefficient, “e±XX” denotes “×10±XX”.

### Numerical Example 1

### Unit mm

### Surface Data

| Surface number | r | d | nd | νd |
|---|---|---|---|---|
| 1 | 361.590 | 8.96 | 1.48749 | 70.2 |
| 2 | −23384.147 | 0.30 | | |
| 3 | 165.569 | 12.81 | 1.43387 | 95.1 |
| 4 | 622.689 | 132.44 | | |
| 5 | 87.354 | 12.05 | 1.43875 | 94.7 |
| 6 | −239.145 | 2.50 | 1.80610 | 33.3 |
| 7 | 57.954 | 0.18 | | |
| 8 | 56.866 | 12.48 | 1.43387 | 95.1 |
| 9 | −360.152 | 0.20 | | |
| 10 | 76.054 | 7.94 | 1.43387 | 95.1 |
| 11 | 814.525 | 2.12 | | |
| 12 | −268.908 | 2.00 | 1.61340 | 44.3 |
| 13 | 59.417 | 10.11 | 1.66382 | 27.4 |
| 14 | −194.105 | 4.41 | | |
| 15 (Aperture) | ∞ | (Variable) | | |
| 16 | 25372.899 | 1.70 | 1.59522 | 67.7 |
| 17 | 71.961 | (Variable) | | |
| 18 | 119.836 | 1.70 | 1.59522 | 67.7 |
| 19 | 58.499 | (Variable) | | |
| 20 | 196.399 | 1.50 | 1.98612 | 16.5 |
| 21 | 116.011 | 3.12 | 1.73800 | 32.3 |
| 22 | −606.051 | 2.33 | | |
| 23 | −179.127 | 3.48 | 1.80000 | 29.8 |
| 24 | −60.919 | 1.50 | 1.57144 | 71.6 |
| 25 | 86.488 | 1.47 | | |
| 26 | 855.808 | 1.50 | 1.80400 | 46.5 |
| 27 | 119.682 | 7.35 | | |
| 28 | −42.017 | 2.00 | 1.49700 | 81.5 |
| 29 | −49.197 | 2.00 | | |
| 30 | 146.161 | 6.69 | 1.85026 | 32.3 |
| 31 | −56.569 | 1.60 | 1.98612 | 16.5 |
| 32 | −95.361 | 56.03 | | |
| 33 | −3569.656 | 2.00 | 1.72825 | 28.5 |
| 34 | ∞ | BF | | |
| Image plane | ∞ | | | |

### Various Data

| | |
|---|---|
| Focal length | 387.98 |
| F number | 2.91 |
| Half angle of view | 3.19 |
| Image height | 21.64 |
| Lens total length | 372.01 |
| BF | 38.28 |

### Distance Between Adjacent Lens Groups on Optical Axis in Infinity Focusing State

| | |
|---|---|
| d15 | 3.44 |
| d17 | 5.07 |
| d19 | 20.74 |
| d34 | 38.28 |

Distance Between Adjacent Lens Groups on the Optical Axis in Focusing at a Close Distance (Position Away from Image Plane Toward Object Side by 2500 mm)

| | |
|---|---|
| d15 | 18.74 |
| d17 | 5.34 |
| d19 | 5.17 |
| d34 | 38.28 |

### Lends Group Data

| Group | Start surface | Focal length |
|---|---|---|
| L1 | 1 | 172.37 |
| L2 | 16 | −121.24 |
| L3 | 18 | −194.02 |
| Lr | 20 | 207.60 |

### Numerical Example 2

### Unit mm

### Surface Data

| Surface number | r | d | nd | νd |
|---|---|---|---|---|
| 1 | 361.590 | 8.96 | 1.48749 | 70.2 |
| 2 | −23384.147 | 0.30 | | |
| 3 | 165.569 | 12.81 | 1.43387 | 95.1 |
| 4 | 622.689 | 132.44 | | |
| 5 | 87.354 | 12.05 | 1.43875 | 94.7 |
| 6 | −239.145 | 2.50 | 1.80610 | 33.3 |
| 7 | 57.954 | 0.18 | | |
| 8 | 56.866 | 12.48 | 1.43387 | 95.1 |
| 9 | −360.152 | 0.20 | | |
| 10 | 76.054 | 7.94 | 1.43387 | 95.1 |
| 11 | 814.525 | 2.12 | | |
| 12 | −268.908 | 2.00 | 1.61340 | 44.3 |
| 13 | 59.417 | 10.11 | 1.66382 | 27.4 |
| 14 | −194.105 | 4.41 | | |
| 15 (Aperture) | ∞ | (Variable) | | |
| 16 | 25372.899 | 1.70 | 1.59522 | 67.7 |
| 17 | 71.961 | (Variable) | | |
| 18 | 119.836 | 1.70 | 1.59522 | 67.7 |
| 19 | 58.499 | (Variable) | | |
| 20 | 196.399 | 1.50 | 1.98612 | 16.5 |
| 21 | 116.011 | 3.12 | 1.73800 | 32.3 |
| 22 | −606.051 | 2.33 | | |
| 23 | −179.127 | 3.48 | 1.80000 | 29.8 |
| 24 | −60.919 | 1.50 | 1.57144 | 71.6 |
| 25 | 86.488 | 1.47 | | |
| 26 | 855.808 | 1.50 | 1.80400 | 46.5 |
| 27 | 119.682 | 7.35 | | |
| 28 | −42.017 | 2.00 | 1.49700 | 81.5 |
| 29 | −49.197 | 2.00 | | |
| 30 | 146.161 | 6.69 | 1.85026 | 32.3 |
| 31 | −56.569 | 1.60 | 1.98612 | 16.5 |
| 32 | −95.361 | 2.48 | | |
| 33 | 22.976 | 8.53 | 1.48749 | 70.2 |
| 34 | 167.264 | 0.17 | | |
| 35 | 51.442 | 3.74 | 1.57501 | 41.5 |
| 36 | 121.848 | 1.00 | 1.90525 | 35.0 |
| 37 | 27.926 | 10.16 | | |
| 38 | −672.196 | 0.95 | 1.72916 | 54.7 |
| 39 | 14.961 | 14.43 | 1.59270 | 35.3 |
| 40 | −15.436 | 0.95 | 1.81600 | 46.6 |
| 41 | 75.686 | 0.65 | | |
| 42 | 31.712 | 9.96 | 1.60342 | 38 |
| 43 | −22.105 | 1.05 | 2.00100 | 29.1 |
| 44 | −102.267 | 1.99 | | |
| 45 | −3569.656 | 2.00 | 1.72825 | 28.5 |
| 46 | ∞ | BF | | |
| Image plane | ∞ | | | |

### Various Data

| | |
|---|---|
| Focal length | 543.19 |
| F number | 4.12 |
| Half angle of view | 2.28 |
| Image height | 21.64 |
| Lens total length | 372.05 |
| BF | 38.30 |

### Distance Between Adjacent Lens Groups on Optical Axis in Infinity Focusing State

| | |
|---|---|
| d15 | 3.44 |
| d17 | 5.07 |
| d19 | 20.74 |
| d46 | 38.30 |

Distance Between Adjacent Lens Groups on the Optical Axis in Focusing at a Close Distance (Position Away from Image Plane Toward Object Side by 2500 mm)

| | |
|---|---|
| d15 | 18.74 |
| d17 | 5.34 |
| d19 | 5.17 |
| d46 | 38.30 |

### Lends Group Data

| Group | Start surface | Focal length |
|---|---|---|
| L1 | 1 | 172.37 |
| L2 | 16 | −121.24 |
| L3 | 18 | −194.02 |
| Lr | 20 | −186.53 |

### Numerical Example 3

### Unit mm

### Surface Data

| Surface number | r | d | nd | νd |
|---|---|---|---|---|
| 1 | 327.048 | 9.19 | 1.48749 | 70.2 |
| 2 | 5245.194 | 0.30 | | |
| 3 | 162.489 | 13.09 | 1.43387 | 95.1 |
| 4 | 608.498 | 127.87 | | |
| 5 | 82.472 | 12.23 | 1.43875 | 94.7 |
| 6 | −289.667 | 2.50 | 1.80610 | 33.3 |
| 7 | 58.126 | 0.38 | | |
| 8 | 57.018 | 12.94 | 1.43387 | 95.1 |
| 9 | −276.265 | 0.20 | | |
| 10 | 81.977 | 6.07 | 1.43387 | 95.1 |
| 11 | 249.715 | 3.52 | | |
| 12 | −218.769 | 2.00 | 1.61340 | 44.3 |
| 13 | 63.275 | 9.73 | 1.66382 | 27.4 |
| 14 | −182.170 | 4.41 | | |
| 15 (Aperture) | ∞ | (Variable) | | |
| 16 | 2790.085 | 1.70 | 1.59522 | 67.7 |
| 17 | 81.683 | 3.94 | | |
| 18 | 90.304 | 1.70 | 1.59522 | 67.7 |
| 19 | 53.932 | (Variable) | | |
| 20 | 150.289 | 1.50 | 1.98612 | 16.5 |
| 21 | 94.557 | 2.95 | 1.73800 | 32.3 |
| 22 | 1100.197 | 2.43 | | |
| 23 | −268.743 | 3.39 | 1.80000 | 29.8 |
| 24 | −68.308 | 1.50 | 1.57144 | 71.6 |
| 25 | 91.910 | 1.49 | | |
| 26 | −2327.604 | 1.50 | 1.80400 | 46.5 |
| 27 | 108.456 | 7.61 | | |
| 28 | −38.536 | 2.00 | 1.49700 | 81.5 |
| 29 | −43.990 | 2.00 | | |
| 30 | 151.525 | 6.64 | 1.85026 | 32.3 |
| 31 | −57.952 | 1.60 | 1.98612 | 16.5 |
| 32 | −92.318 | 52.26 | | |
| 33 | −2821.222 | 2.00 | 1.72825 | 28.5 |
| 34 | ∞ | BF | | |

### Various Data

| | |
|---|---|
| Focal length | 387.99 |
| F number | 2.91 |
| Half angle of view | 3.19 |
| Image height | 21.64 |
| Lens total length | 366.59 |
| BF | 38.51 |

### Distance Between Adjacent Lens Groups on Optical Axis in Infinity Focusing State

| | |
|---|---|
| d15 | 3.40 |
| d19 | 24.03 |
| d34 | 38.51 |

Distance Between Adjacent Lens Groups on the Optical Axis in Focusing at a Close Distance (Position Away from Image Plane Toward Object Side by 2500 mm)

| | |
|---|---|
| d15 | 21.69 |
| d19 | 5.74 |
| d34 | 38.51 |

### Lends Group Data

| Group | Start surface | Focal length |
|---|---|---|
| L1 | 1 | 182.22 |
| L2 | 16 | −85.88 |
| Lr | 20 | 241.88 |

### Numerical Example 4

### Unit mm

### Surface Data

| Surface number | r | d | nd | νd |
|---|---|---|---|---|
| 1 | 425.413 | 5.58 | 1.48749 | 70.2 |
| 2 | 1011.838 | 0.20 | | |
| 3 | 160.647 | 9.15 | 1.43387 | 95.1 |
| 4 | 296.502 | 4.68 | | |
| 5 | 296.502 | 7.00 | 1.52841 | 76.5 |
| 6 | 774.718 | 156.50 | | |
| 7 | 73.158 | 14.86 | 1.43875 | 94.7 |
| 8 | −88.608 | 2.50 | 1.80610 | 33.3 |
| 9 | 49.119 | 0.18 | | |
| 10 | 49.167 | 11.92 | 1.43387 | 95.1 |
| 11 | −393.429 | 0.20 | | |
| 12 | 86.394 | 4.64 | 1.53775 | 74.7 |
| 13 | 179.098 | 0.25 | | |
| 14 | 77.706 | 2.00 | 1.61340 | 44.3 |
| 15 | 62.770 | 10.09 | 1.66382 | 27.4 |
| 16 | −131.534 | 4.41 | | |
| 17 (Aperture) | ∞ | (Variable) | | |
| 18 | −312.795 | 1.70 | 1.59522 | 67.7 |
| 19 | 71.714 | (Variable) | | |
| 20 | −413.700 | 1.70 | 1.59522 | 67.7 |
| 21 | 47.958 | (Variable) | | |
| 22 | 1834.208 | 1.50 | 1.98612 | 16.5 |
| 23 | 78.236 | 5.09 | 1.73800 | 32.3 |
| 24 | −58.171 | 1.00 | | |
| 25 | 822.148 | 3.48 | 1.80000 | 29.8 |
| 26 | −71.260 | 1.50 | 1.57144 | 71.6 |
| 27 | −552.268 | 0.88 | | |
| 28 | −152.904 | 1.50 | 1.80400 | 46.5 |
| 29 | 51.689 | 10.07 | | |
| 30 | −34.092 | 2.00 | 1.49700 | 81.5 |
| 31 | −44.191 | 5.00 | | |
| 32 | 92.722 | 4.77 | 1.85026 | 32.3 |
| 33 | −256.516 | 1.60 | 1.98612 | 16.5 |
| 34 | −271.981 | 23.21 | | |
| 35 | 487.337 | 2.00 | 1.51742 | 52.4 |
| 36 | ∞ | BF | | |
| Image plane | ∞ | | | |

### Various Data

| | |
|---|---|
| Focal length | 387.99 |
| F number | 2.91 |
| Half angle of view | 3.19 |
| Image height | 21.64 |
| Lens total length | 366.59 |
| BF | 38.51 |

### Distance Between Adjacent Lens Groups on Optical Axis in Infinity Focusing State

| | |
|---|---|
| d17 | 3.22 |
| d19 | 5.52 |
| d21 | 24.08 |
| d36 | 38.09 |

Distance Between Adjacent Lens Groups on the Optical Axis in Focusing at a Close Distance (Position Away from Image Plane Toward Object Side by 2500 mm)

| | |
|---|---|
| d17 | 4.48 |
| d19 | 22.67 |
| d21 | 5.67 |
| d36 | 38.09 |

### Lends Group Data

| Group | Start surface | Focal length |
|---|---|---|
| L1 | 1 | 125.88 |
| L2 | 18 | −97.85 |
| L3 | 20 | −72.10 |
| Lr | 22 | 156.02 |

### Numerical Example 5

### Unit mm

### Surface Data

| Surface number | r | d | nd | νd |
|---|---|---|---|---|
| 1* | 218.187 | 5.14 | 1.48749 | 70.2 |
| 2* | 531.225 | 0.30 | | |
| 3 | 112.850 | 15.44 | 1.43387 | 95.1 |
| 4 | −824.686 | 86.36 | | |
| 5 | 72.081 | 7.08 | 1.43875 | 94.7 |
| 6 | −240.031 | 2.00 | 1.77047 | 29.7 |
| 7 | 29.896 | 0.15 | | |
| 8 | 29.769 | 8.41 | 1.43387 | 95.1 |
| 9 | 155.824 | 0.20 | | |
| 10 | 41.829 | 4.70 | 1.43387 | 95.1 |
| 11 | 83.309 | 3.40 | | |
| 12 | 104.933 | 1.00 | 1.61340 | 44.3 |
| 13 | 31.853 | 8.02 | 1.66382 | 27.4 |
| 14 | −149.804 | 4.41 | | |
| 15 (Aperture) | ∞ | (Variable) | | |
| 16 | 82.652 | 1.00 | 1.59522 | 67.7 |
| 17 | 23.645 | (Variable) | | |
| 18 | −63.608 | 1.00 | 1.59522 | 67.7 |
| 19 | 96.881 | (Variable) | | |
| 20 | 44.040 | 1.00 | 1.98612 | 16.5 |
| 21 | 29.858 | 4.60 | 1.73800 | 32.3 |
| 22 | 2010.829 | 1.36 | | |
| 23 | 202.596 | 2.67 | 1.80000 | 29.8 |
| 24 | −142.939 | 1.00 | 1.49700 | 81.5 |
| 25 | 36.341 | 3.50 | | |
| 26 | −124.648 | 1.00 | 1.80400 | 46.5 |
| 27 | 172.170 | 2.30 | | |
| 28 | 65.689 | 6.92 | 1.59270 | 35.3 |
| 29 | −49.837 | 1.60 | 1.98612 | 16.5 |
| 30 | −63.773 | 5.61 | | |
| 31 | 259.527 | 2.00 | 1.77047 | 29.7 |
| 32 | ∞ | BF | | |
| Image plane | ∞ | | | |

### Aspherical Surface Data

### First Surface

K=0.00000e+00 A4=−2.06568e−08 A6=−9.98483e−12 A8=−8.83084e−16 A10=−8.74981e−19

### Second Surface

K=0.00000e+00 A4=3.66431e−08 A6=−8.68897e−12 A8=−9.59089e−16 A10=−7.91548e−19

### Various Data

| | |
|---|---|
| Focal length | 289.77 |
| F number | 2.91 |
| Half angle of view | 4.27 |
| Image height | 21.64 |
| Lens total length | 240.23 |
| BF | 37.97 |

### Distance Between Adjacent Lens Groups on Optical Axis in Infinity Focusing State

| | |
|---|---|
| d15 | 2.68 |
| d17 | 10.08 |
| d19 | 7.31 |
| d32 | 37.97 |

Distance Between Adjacent Lens Groups on the Optical Axis in Focusing at a Close Distance (Position Away from Image Plane Toward Object Side by 2500 mm)

| | |
|---|---|
| d15 | 9.83 |
| d17 | 7.30 |
| d19 | 2.95 |
| d32 | 37.97 |

### Lends Group Data

| Group | Start surface | Focal length |
|---|---|---|
| L1 | 1 | 120.96 |
| L2 | 16 | −56.00 |
| L3 | 18 | −64.36 |
| Lr | 20 | 70.39 |

Various values in the numerical examples are collectively presented in Table 1 below.

| | Inequality | Example 1 | Example 2 | Example 3 | Example 4 | Example 5 |
|---|---|---|---|---|---|---|
| Inequality (1) | vd | 94.7, 95.1, 95.1 | 94.7, 95.1, 95.1 | 94.7, 95.1, 95.1 | 94.7, 95.1, 74.7 | 94.7, 95.1, 95.1 |
| Inequality (2) | Dmax/f1 | 0.768 | 0.768 | 0.702 | 1.243 | 0.714 |
| Inequality (3) | OTL/f | 0.959 | 0.685 | 0.945 | 0.960 | 0.829 |
| Inequality (4) | f1a/f | 0.781 | 0.558 | 0.766 | 0.859 | 0.586 |
| Inequality (5) | f1/f | 0.444 | 0.317 | 0.470 | 0.325 | 0.417 |
| Inequality (6) | fla_min/f1 | 2.990 | 2.990 | 2.779 | 6.291 | 1.052 |
| Inequality (7) | vd_min | 33.269 | 33.269 | 33.269 | 33.269 | 29.736 |
| Inequality (8) | Bab_max/Fno | 1.216 | 1.683 | 1.367 | 1.919 | 1.525 |
| Inequality (9) | BF/IH | 1.770 | 1.770 | 1.780 | 1.760 | 1.755 |
| Inequality (10) | f1b/f | 0.458 | 0.327 | 0.548 | 0.208 | 0.415 |

### [Imaging Apparatus]

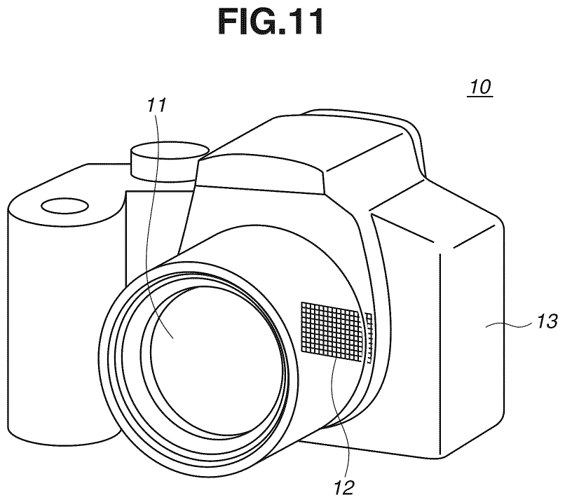

An example of a digital still camera (imaging apparatus) 10 using an optical system according to an aspect of the disclosure as an imaging optical system will be described below with reference to FIG. 11. In FIG. 11, an imaging optical system 11 includes the optical system according to any one of the first to fifth examples. An image sensor (photoelectric conversion element) 12 is an image sensor, such as a CCD or CMOS sensor, which is built into a camera body 13, receives an optical image formed by the imaging optical system 11, and performs photoelectric conversion on the optical image. The camera body 13 may be a so-called single-lens reflex camera with a quick-turn mirror, or a so-called mirrorless camera without a quick-turn mirror”.

By applying the optical system L0 according to an aspect of the disclosure to an imaging apparatus, such as a digital still camera, a high-resolution image with a wide field of view is obtained.

Although the exemplary embodiments and examples of the disclosure have been described above, the disclosure is not limited to these exemplary embodiments and examples, and various combinations, modifications, and changes can be made within the scope of the gist of the disclosure.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-009256, filed Jan. 25, 2024, which is hereby incorporated by reference herein in its entirety.

What is claimed is:

1. An optical system comprising:
a first lens unit having positive refractive power,
an intermediate group including one or more lens units, and
a final lens unit, disposed in this order from an object side to an image side, with a distance between adjacent lens units that changes during focusing,
wherein the first and final lens units remain stationary for focusing,
wherein the first lens unit consists of a first subunit including a plurality of positive lenses and a second subunit, disposed in this order from the object side to the image side,
wherein the first and second subunits are disposed with an air gap between the first and second subunits that is the largest air gap formed in the optical system,
wherein each of materials of at least three positive lenses disposed in the second subunit satisfies the following inequality:
70.0<νd<100.0,
where νd is an Abbe number based on the d-line, and
wherein the following inequality is satisfied:
$$0.7 < D max / f < 1.5 ,$$
where Dmax is the air gap between the first and second subunits, and f1 is a focal length of the first lens unit.

2. The optical system according to claim 1, wherein the following inequality is satisfied:
$$0.45 < OTL / f < 1.2 ,$$
where OTL is a distance along an axis from a lens surface closest to the object side to a plane in the optical system, and f is a focal length of an entire system.

3. The optical system according to claim 1, wherein the following inequality is satisfied:
$$0.2 < f 1 a / f < 1. ,$$
where f1a is a focal length of the first subunit, and f is a focal length of an entire system.

4. The optical system according to claim 1, wherein the following inequality is satisfied:
$$0.2 < f 1 / f < 0.8 ,$$
where f is a focal length of an entire system.

5. The optical system according to claim 1, wherein the following inequality is satisfied:
$$1.5 < f 1 a\_min / f 1 < 8. ,$$
where f1a_min is a focal length of a positive lens having the shortest focal length among the plurality of positive lenses disposed in the first lens unit.

6. The optical system according to claim 1, wherein the following inequality is satisfied:
10.0<νd_min<35.0,
where νd_min is a minimum value of the Abbe number of the material of the positive lenses disposed in the second subunit.

7. The optical system according to claim 1, wherein the following inequality is satisfied:
$$0.5 < Bab\_max / Fno < 2. ,$$
where Bab_max is a maximum absolute value of position sensitivity of the one or more lens units disposed in the intermediate group and configured to move during focusing, and Fno is an f-number of the optical system.

8. The optical system according to claim 1, wherein the following inequality is satisfied:
$$1.3 < BF / IH < 5. ,$$
where BF is a distance along an axis from a lens surface closest to the image side to a plane in the optical system, and IH is a maximum image height.

9. The optical system according to claim 1, wherein the following inequality is satisfied:
$$0.1 < f 1 b / f < 0.8 ,$$
where f1b is a focal length of the second subunit, and f is a focal length of an entire system.

10. The optical system according to claim 1, wherein the first subunit consists of two positive lenses.

11. The optical system according to claim 1, wherein the intermediate group has negative refractive power.

12. The optical system according to claim 1, wherein the second subunit includes two negative lenses.

13. The optical system according to claim 1, wherein the final lens unit moves partially or entirely in a direction that includes a component of a direction perpendicular to an axis during blur correction.

14. The optical system according to claim 1, wherein the optical system includes an aperture stop disposed in a position closest to the image side in the first lens unit.

15. An optical system comprising:
a first lens unit having positive refractive power,
an intermediate group including one or more lens units, and
a final lens unit, disposed in this order from an object side to an image side, with a distance between adjacent lens units that changes during focusing,
wherein the first and final lens units remain stationary for focusing,
wherein the first lens unit consists of a first subunit including a plurality of positive lenses and a second subunit, disposed in this order from the object side to the image side,
wherein the first and second subunits are disposed with an air gap between the first and second subunits that is the largest air gap formed in the optical system,
wherein the final lens unit includes four or more negative lenses, and
wherein the following inequality is satisfied:
$$0.4 < D max / f 1 < 1.5 ,$$
where Dmax is the air gap between the first and second subunits, and f1 is a focal length of the first lens unit.

16. An optical system comprising:
a first lens unit having positive refractive power,
an intermediate group including one or more lens units, and
a final lens unit, disposed in this order from an object side to an image side, with a distance between adjacent lens units that changes during focusing,
wherein the first and final lens units remain stationary for focusing,
wherein the first lens unit consists of a first subunit including a plurality of positive lenses and a second subunit, disposed in this order from the object side to the image side,
wherein the first and second subunits are disposed with an air gap between the first and second subunits that is the largest air gap formed in the optical system,
wherein the final lens unit includes four or more negative lenses, and
wherein each of materials of at least three positive lenses disposed in the second subunit satisfies the following inequality:
70.0<νd<100.0,
where νd is an Abbe number based on the d-line.

17. An apparatus comprising:
an optical system, and
a sensor configured to receive an image formed by the optical system,
wherein the optical system comprises a first lens unit having positive refractive power, an intermediate group including one or more lens units, and a final lens unit, disposed in this order from an object side to an image side, and a distance between adjacent lens units changes during focusing,
wherein the first and final lens units remain stationary for focusing,
wherein the first lens unit consists of a first subunit including a plurality of positive lenses and a second subunit, disposed in this order from the object side to the image side,
wherein the first and second subunits are disposed with an air gap between the first and second subunits that is the largest air gap formed in the optical system,
wherein each of materials of at least three positive lenses disposed in the second subunit satisfies the following inequality:
70.0<νd<100.0,
where νd is an Abbe number based on the d-line, and
wherein the following inequality is satisfied:
$$0.7 < D max / f 1 < 1.5 ,$$
where Dmax is the air gap between the first subunit and the second subunit, and f1 is a focal length of the first lens unit.
